(19) United States
(12) Patent Application Publication
(10) Pub. No.: US 2016/0169136 A1
(43) Pub. Date: Jun. 16, 2016

(54) Systems and Methods for Controlling Air-to-Fuel Ratio Based on Catalytic Converter Performance

(71) Applicant: GENERAL ELECTRIC COMPANY, Schenectady, NY (US)

(72) Inventors: Maruthi Narasinga Rao Devarakonda, Waukesha, WI (US); Prashant Srinivasan, Bangalore (IN); Medy Satria, Muenchen (DE); Rohit Mahakali, Bangalore (IN); Sharath Sridhar Aramanekoppa, Bangalore (IN)

(21) Appl. No.: 14/569,225

(22) Filed: Dec. 12, 2014

(51) Int. Cl. F02D 41/02; F01N 11/00

(52) U.S. Cl. CPC F02D 41/0235; F01N 11/007

(57) ABSTRACT

A system includes a controller that has a processor. The processor is configured to receive a first signal from a first oxygen sensor indicative of a first oxygen measurement and a second signal from a second oxygen sensor indicative of a second oxygen measurement. The first oxygen sensor is disposed upstream of a catalytic converter system and the second oxygen sensor is disposed downstream of the catalytic converter system. The processor is also configured to derive a plurality of oxygen storage estimates based on the first signal, the second signal, and a catalytic converter model. Each of the plurality of oxygen storage estimates represents an oxygen storage estimate for a corresponding cell of a plurality of cells in the catalytic converter system. Further, the processor is configured to derive a system oxygen storage estimate for the catalytic converter system based on the plurality of oxygen storage estimates. The processor is also configured to derive a system oxygen storage setpoint for the catalytic converter system based on the catalytic converter model. The processor is then configured to compare the system oxygen storage estimate to the system oxygen storage setpoint and apply the comparison during control of a gas engine.

### BACKGROUND

The subject matter disclosed herein relates to catalytic converter systems for gas engine systems. Specifically, the subject matter described below relates to systems and methods for controlling the air-fuel ratio of a gas engine system based on a corresponding catalytic converter system.

Gas engine systems provide power for a variety of application, such as oil and gas processing systems, commercial and industrial buildings, and vehicles. Many gas engine systems include or are coupled to a control system that oversees the operation of the gas engine system. The control system may improve efficiency of the gas engine system, and provide other functionality. For example, the control system may improve the efficiency of the gas engine system by controlling the air-to-fuel ratio of the gas engine, which represents the amount of air provided to the gas engine relative to the amount of fuel provided to the gas engine. Depending on desired applications, the control system may try to keep the air-to-fuel ratio near stoichiometry, which is the ideal ratio at all of the fuel is burned using all of the available oxygen. Other applications may keep the air-to-fuel ratio in a range between rich (i.e., excess fuel) and lean (i.e., excess air).

As will be appreciated, gas engine systems produce exhaust gases as a result of burning fuel; and the type of exhaust gases emitted may depend in part on the type and amount of fuel provided to the gas engine system. Many industries and jurisdictions (e.g., coal-burning plants, federal and state governments, etc.) may have regulations and restrictions specifying the types and amounts of exhaust gases that different gas engine systems are permitted to emit.

To comply with regulations and restrictions, the gas engine system may also include a catalytic converter system coupled to the gas engine. The catalytic converter system receives the exhaust gases and substantially converts the exhaust gases into other types of gases permitted by regulations and restrictions. The performance of the catalytic converter system may impact the performance of the gas engine, and vice versa. It would be beneficial to improve the performance of the gas engine and catalytic convertor systems via the control system.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a controller that has a processor. The processor is configured to receive a first signal from a first oxygen sensor indicative of a first oxygen measurement and a second signal from a second oxygen sensor indicative of a second oxygen measurement. The first oxygen sensor is disposed upstream of a catalytic converter system and the second oxygen sensor is disposed downstream of the catalytic converter system. The processor is also configured to derive a plurality of oxygen storage estimates based on the first signal, the second signal, and a catalytic converter model. Each of the plurality of oxygen storage estimate represents an oxygen storage estimate for a corresponding cell of a plurality of cells in the catalytic converter system. Further, the processor is configured to derive a system oxygen storage estimate for the catalytic converter system based on the plurality of oxygen storage estimates. The processor is also configured to derive a system oxygen storage setpoint for the catalytic converter system based on the catalytic converter model. The processor is then configured to compare the system oxygen storage estimate to the system oxygen storage setpoint and apply the comparison during control of a gas engine.

In a second embodiment, a system includes a gas engine system that has a gas engine fluidly coupled to a catalytic converter system and a catalytic controller operatively coupled to the gas engine and communicatively coupled to the catalytic converter. The catalytic controller has a processor configured to receive a first signal from a first oxygen sensor indicative of a first oxygen measurement and a second signal from a second oxygen sensor indicative of a second oxygen measurement. The first oxygen sensor is disposed upstream of the catalytic converter system and the second oxygen sensor is disposed downstream of the catalytic converter system. The processor is also configured to select a first catalytic converter model from a plurality of offline catalytic converter models. The selected catalytic converter model corresponds to an estimate of a behavior of the catalytic converter system. The processor is further configured to then derive a plurality of oxygen storage estimates based on the first signal, the second signal, and the first catalytic converter model. Each of the plurality of oxygen storage estimates represents an oxygen storage estimate for a corresponding cell of a plurality of cells in the catalytic converter system. The processor is also configured to derive a system oxygen storage estimate for the catalytic converter system based on a combination of plurality of oxygen storage estimates. Further, the processor is configured to derive a plurality of oxygen storage setpoints based on the first catalytic converter model. Each of the plurality of oxygen storage setpoints represents an oxygen storage setpoint for a corresponding cell of the plurality of cells in the catalytic converter system. The processor is then configured to derive a system oxygen storage setpoint based on a combination of the plurality of oxygen storage setpoints. Further, the processor is configured to compare the system oxygen storage estimate to the system oxygen storage setpoint and derive an air-to-fuel ratio (AFR) setpoint based on the comparison. The AFR setpoint is applied to control the gas engine.

In a third embodiment, a tangible, non-transitory computer-readable medium includes executable instructions. The instructions are configured to receive a first signal from a first oxygen sensor indicative of a first oxygen measurement and a second signal from a second oxygen sensor indicative of a second oxygen measurement. The first oxygen sensor is disposed upstream of a catalytic converter system and the second oxygen sensor is disposed downstream of the catalytic converter system. The instructions are also configured to derive a plurality of oxygen storage estimates based on the first signal, the second signal, and a catalytic converter model. Each of the plurality of oxygen storage estimate represents an oxygen storage estimate for a corresponding cell of a plurality of cells in the catalytic converter system. Further, the instructions are configured to derive a system oxygen storage estimate for the catalytic converter system based on the plurality of oxygen storage estimates. The instructions are also configured to derive an oxygen storage setpoint for the catalytic converter system based on the catalytic converter model, and to compare the system oxygen storage estimate to the oxygen storage setpoint.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a gas engine system, in accordance with an embodiment of the present approach;

FIG. 2 is a block diagram of an engine control unit for the gas engine system of FIG. 1, in accordance with an embodiment of the present approach;

FIG. 3 is a cross-sectional of a catalytic converter system included in the gas engine system of FIG. 1, in accordance with an embodiment of the present approach;

FIG. 4 is a block diagram of a catalyst monitoring system included in the gas engine system of FIG. 1, in accordance with an embodiment of the present approach;

FIG. 5 is a flow chart depicting a method of operation for the catalyst monitoring system of FIG. 4, in accordance with an embodiment of the present approach; and

FIG. 6 is a flow chart depicting a control process derived from the method of FIG. 5, in accordance with an embodiment of the present approach.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments relate to controlling the air-to-fuel ratio (AFR) of a gas engine based on the observations of a catalytic converter coupled to the gas engine. The embodiments described herein relate to a monitoring system that estimates the behavior of the catalytic converter, for example, by executing certain models described in more detail below. The monitoring system may account for different operating states and conditions of the gas engine and the catalytic converter, which may increase the accuracy of the estimates. The monitoring system may also determine performance setpoints for the catalytic converter, and may compare the estimates to the performance setpoints. A control system that oversees the operation of the gas engine may then determine a setpoint for the AFR based on the comparison between the catalytic converter performance setpoints and the estimates. The control system may then adjust the AFR accordingly. The monitoring system may also use the estimated behavior of the catalytic converter for diagnostic purposes.

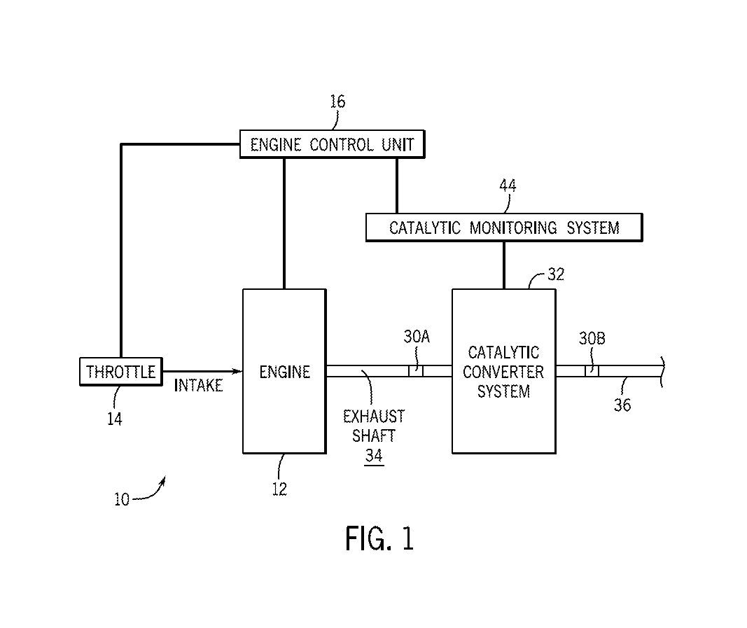

Turning now to FIG. 1, a gas engine system 10 is depicted, suitable for combusting fuel to produce power for a variety of applications, such as power generation systems, oil and gas systems, commercial and industrial buildings, vehicles, landfills, and wastewater treatment. The gas engine 10 system includes a gas engine 12, such as a Waukesha™ gas engine available from the General Electric Company of Schenectady, N.Y. The gas engine system 10 also includes a throttle 14 coupled to the gas engine 12. The throttle 14 may be a valve whose position controls the amount of fuel or air provided to the gas engine 12. As such, the position of the throttle 14 partly determines an air-to-fuel ratio (AFR) of the gas engine 12. The AFR represents the ratio between an amount of oxygen available to combust an amount of fuel provided to the gas engine 12.

The gas engine system 10 further includes an engine control unit 16, which may control the operation of the gas engine system 10, which is described in further detail below. To that end, the gas engine system 10 also includes sensors and actuators that may be used by the engine control unit 16 to perform various tasks. For example, as shown in FIG. 1, the gas engine system 10 may include two oxygen sensors 30A and 30B that are disposed at different locations in the gas engine system 10 and provide signals correlative to oxygen measurements for that particular location.

The gas engine 12 may emit certain types and amounts of exhaust gases based on the type of fuel used. Certain industries and organizations (e.g., the oil and gas industry, coal-burning plants, federal and state governments, etc.) may have restrictions and regulations that specify the types and amounts of exhaust gases gas engines are permitted to emit.

To comply with these restrictions and regulations, the gas engine system 10 includes a catalytic converter system 32 coupled to an exhaust conduit 34 of the gas engine 12. The catalytic converter system 32 receives the exhaust gases from the gas engine 12 and captures the exhaust gas and/or converts the exhaust gases into other types of emissions permitted by restrictions and regulations. For example, the catalytic converter system 30 depicted in FIG. 1 may performs three conversions: 1.) converting nitrogen oxides to nitrogen and oxygen, 2.) converting carbon monoxide to carbon dioxide, and 3.) converting unburned hydrocarbons to carbon dioxide and water. That is, the catalytic converter system 32 depicted in FIG. 1 is a three-way catalyst. Other embodiments may use other types of catalytic converters. The converted gases may then exit the catalytic converter system 32 via an output conduit 36, which may lead to another component of the gas engine system 10 (e.g., another catalytic converter 32, a heat recovery system) or to a vent.

To oversee the catalytic converter system 32, the gas engine system 10 includes a catalyst monitoring system 44, as shown in FIG. 1 and described in further detail below. The catalyst monitoring system 44 may be part of the engine control unit 16 or may be a separate system that communicates with the engine control unit 16.

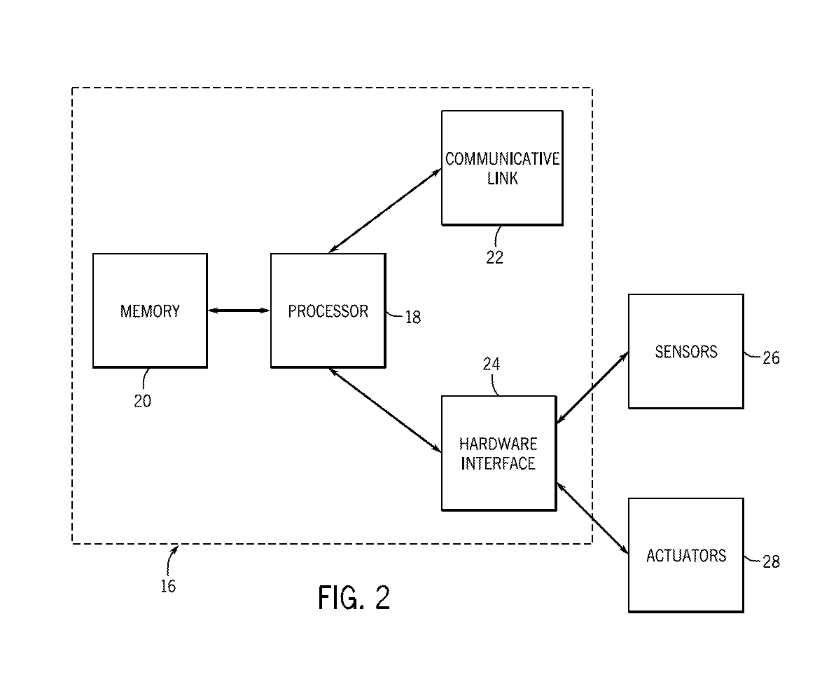

Turning now to FIG. 2, the engine control unit 16 includes a processor 18; a memory 20, a communicative link 22 to other systems, components, and devices; and a hardware interface 24 suitable for interfacing with sensors 26 and actuators 28, as illustrated in FIG. 2. The processor 18 may include, for example, general-purpose single- or multi-chip processors. In addition, the processor 18 may be any conventional special-purpose processor, such as an application-specific processor or circuitry. The processor 18 and/or other data processing circuitry may be operably coupled to the memory 20 to execute instructions for running the engine control unit 16. These instructions may be encoded in programs that are stored in the memory 20. The memory 20 may be an example of a tangible, non-transitory computer-readable medium, and may be accessed and used to execute instructions via the processor 18.

The memory 20 may be a mass storage device (e.g., hard drive), a FLASH memory device, a removable memory, or any other non-transitory computer-readable medium. Additionally or alternatively, the instructions may be stored in an additional suitable article of manufacture that includes at least one tangible, non-transitory computer-readable medium that at least collectively stores these instructions or routines in a manner similar to the memory 20 as described above. The communicative link 22 may be a wired link (e.g., a wired telecommunication infrastructure or a local area network employing Ethernet) and/or wireless link (e.g., a cellular network or an 802.11x Wi-Fi network) between the engine control unit 16 and other systems, components, and devices.

The sensors 26 may provide various signals to the engine control unit 16. For example, as mentioned above, the oxygen sensors 30A and 30B disposed at different locations in the gas engine system 10 provide signals correlative to oxygen measurements for that particular location. The actuators 28 may include valves, pumps, positioners, inlet guide vanes, switches, and the like, useful in performing control actions. For instance, the throttle 14 is a specific type of actuator 28.

Based on signals received from the sensors 26, the engine control unit 16 may determine if one or more control aspects of the gas engine system 10 should be changed and adjusts the control aspect accordingly using an actuator 28. For instance, the engine control unit 16 may endeavor to improve the efficiency of the gas engine 12 by controlling the AFR of the gas engine 12. In particular, the engine control unit 16 may attempt to keep the AFR of the gas engine 12 at a desired ratio, such as near stoichiometry. As mentioned earlier, stoichiometry describes the ideal AFR ratio at which all of the provided fuel is burned using all of the available oxygen. In other embodiments, the engine control unit 16 may attempt to keep the AFR of the gas engine 12 within a narrow band of acceptable values, including values where the AFR includes rich (i.e., excess fuel) burns and lean (i.e., excess air) burns, depending on desired engine 12 applications.

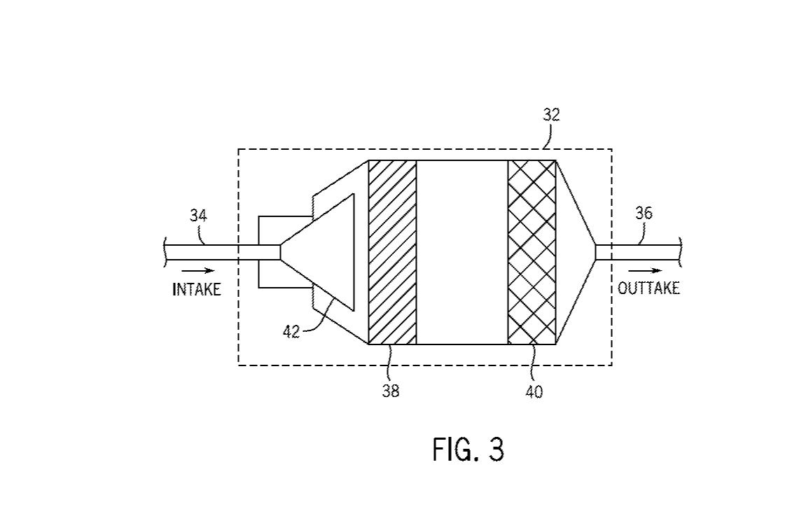

Turning now to FIG. 3, the catalytic converter system 32 may include at least two catalytic structures, a reduction catalyst 38 and an oxidation catalyst 40. Both of the catalytic structures may be ceramic structures coated with a metal catalyst, such as platinum, rhodium, and palladium. The catalytic structures may be honeycomb shaped or ceramic beads, and may be divided into cells, which are measured per square inch.

As depicted in FIG. 3, the exhaust gases, coming from the exhaust conduit 34, first encounter the reduction catalyst 38. The reduction catalyst 38 may be coated with platinum and rhodium, and reduces the nitrogen oxides in the exhaust gases to nitrogen and oxygen. Next, the gases encounter the oxidation catalyst 40, which may be coated with palladium and rhodium. The oxidation catalyst 38 oxidizes the unburned hydrocarbons in the exhaust gases to carbon dioxide and water, and the carbon monoxide in the exhaust gases to carbon dioxide. Finally, the converted gases exit the catalytic converter system via the output shaft 36.

In certain embodiments, the catalytic converter system 32 may include a diffuser 42 positioned between the exhaust shaft 34 and the reduction catalyst 38. The diffuser 42 scatters the exhaust gases evenly across the width of the catalytic structures in the catalytic converter system 32. As a result, a larger amount of the exhaust gases may come into contact with the front end of the catalytic structures, allowing them to convert a large amount of the exhaust gases within a shorter distance. Further, scattering the exhaust gases using the diffuser 34 may also reduce the likelihood that different areas of the catalytic structures age at varying rates due to different concentration of the exhaust gases in particular areas.

As mentioned above, the engine control unit 16 may control the AFR of the gas engine 12 so as to improve the efficiency of the gas engine 12. To do so, the engine control unit 16 may monitor a number of factors, such as the exhaust gas composition entering and/or exiting the catalytic converter system 32, in order to determine any adjustments to the AFR of the gas engine 12. In many situations, the performance of the catalytic converter system 32 may also provide an indication of whether and how the AFR of the gas engine 12 should be adjusted. For example, if the amount of oxidation of exhaust gases is below a certain threshold, it may be an indication that the gas engine is not receiving enough oxygen and the air-to-fuel ratio should be adjusted to become leaner.

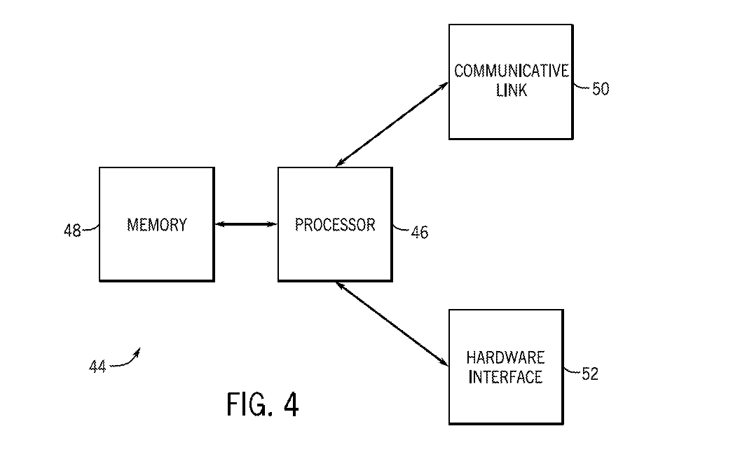

To improve the control of the AFR of the gas engine 12, the engine control unit 16 may work in conjunction with the catalyst monitoring system 44. That is, the engine control unit 16 may control the AFR of the gas engine 12 based on feedback from the catalyst monitor system 44. As depicted in FIG. 4, the catalyst monitoring system 44 may include a processor 46, a memory 48, a communicative link 50, and a hardware interface 52. These components may include hardware components similar to the processor 18, the memory 20, the communicative link 22, and the hardware interface 24 of the engine control unit 16.

In certain embodiments, the catalyst monitoring system 44 may be a proportional-integral-derivative (PID) controller with an anti-windup mode. As will be appreciated, windup occurs in a PID controller when the controller determines how to adjust an actuator according to a grade that cannot physically be achieved. For example, a PID controller with windup may determine that a valve should be open 175 degrees, when in reality the valve can only be opened 150 degrees. As such, it may be advantageous to use a PID controller with an anti-windup mode as described herein, which may align the grading scales of the PID controller with the physical limitations of the corresponding actuators.

As mentioned above, the catalyst monitoring system 44 monitors the operation of the catalytic converter system 32. In particular, the catalyst monitoring system 44 monitors the oxygen storage dynamics of the catalytic converter system 32. Ideally, the catalytic converter system 32 receives suitable oxygen from the fuel or the oxidation structure 40 to oxidize the unburned hydrocarbons and/or the carbon monoxide. That is, the amount of oxygen received from fuel or stored in the oxidation structure 40 may then determine the performance of the catalytic converter system 32 for two of its main functions, converting unburned hydrocarbons to carbon dioxide and water and carbon monoxide to carbon dioxide. As such, the oxygen storage dynamics of the catalytic converter system 32 may be a suitable indicator of the performance of the catalytic converter system 32. However, it should be appreciated that the catalyst monitoring system 44 may be used to monitor other performance indicators for the catalytic converter system 32.

To evaluate the oxygen storage dynamics of the catalytic converter system 32, the catalyst monitoring system 44 estimates the oxygen storage dynamics of the catalytic converter system 32. The catalyst monitoring system also determines a system oxygen storage setpoint for the catalytic converter system 32 as well as individual oxygen storage setpoints for each cell of the catalytic converter system 32, which are then compared to the oxygen storage estimates. The engine control unit 16 then determines a setpoint for the AFR of the gas engine 12 based on the comparison between the oxygen storage estimates and the oxygen storage setpoints and adjusts the AFR accordingly. In certain embodiments, the catalyst monitoring system 44 may determine the AFR setpoint instead of the engine control unit 16. Further, the catalyst monitoring system 44 may adjust the AFR in certain embodiments. Regardless, the AFR setpoint may then be used by the engine control unit 16 to provide for control of various actuators, including fuel delivery actuators, and so on.

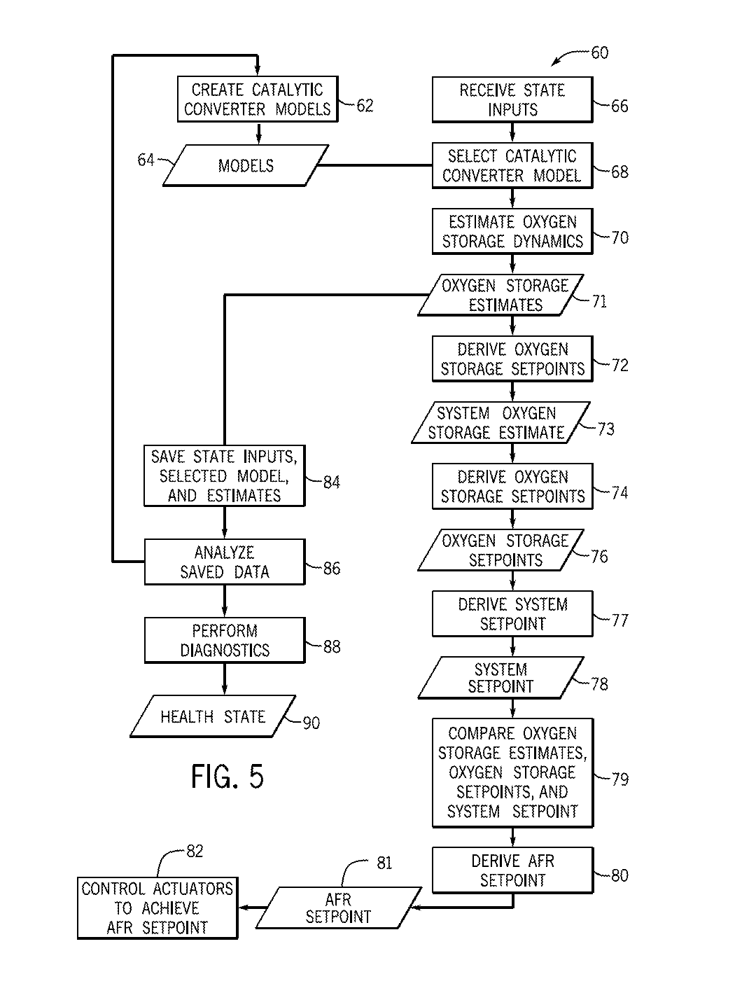

FIG. 5 depicts an embodiment of a process of operation 60 for the catalyst monitoring system 44. Although the process 60 is described below in detail, the process 60 may include other steps not shown in FIG. 5. Additionally, the steps illustrated may be performed concurrently or in a different order. Further, as will be appreciated, a portion of the steps of process 60 may be performed while the gas engine system 10 is offline (i.e., not in operation).

Beginning at block 62, the catalyst monitoring system 44 creates a set of physical catalytic converter models 64. The catalyst monitoring system 44 may employ a model-based control (MBC) technique, in which operating states and conditions of the gas engine system 10 are treated as individual states. In such embodiments, the catalyst monitoring system 44 may create catalytic converter models 64 based on each individual operating state, each individual operating conditions, or each combination of the individual operating state and operating conditions. The catalytic converter models 64 may be created during offline simulations of the gas engine system 10 and then be saved in the memory 48 (e.g., as look-up tables) for access during other steps of the process 60.

At block 66, the catalyst monitoring system 44 receives a variety of inputs concerning the state of the gas engine system 10 and the catalytic converter system 32. In particular, the catalyst monitoring system 44 receives data from at least the oxygen sensors 30A and 30B, the former of which is disposed upstream of the catalytic converter system 32 (pre-cat O2 sensor) and the latter of which is disposed downstream of the catalytic converter system 32 (post-cat O2 sensor). In certain embodiments, the catalyst monitoring system 44 may also receive data from an oxygen sensor(s) disposed in the catalytic converter system 30 (e.g., mid-cat O2 sensor).

The catalyst monitoring system 44 then selects a catalytic converter model 64 based on the received inputs at block 68. These inputs can include the total air mass flow, the exhaust gas temperature, the oxygen storage capacity of the oxidation structure 40, the Gibbs energy of the oxidation structure 40, the inlet gas composition, and the like. The received inputs include physical characteristics of the catalytic converter system 32 (e.g., the oxygen storage capacity and Gibbs energy of the oxidation structure 40) that may be stored on the memory 48, as well as empirical data (e.g., the exhaust gas temperature and the inlet gas composition) that is measured by one or more sensors 26.

Next, at block 70, the catalyst monitoring system 44 estimates the oxygen storage dynamics 71 of the catalytic converter system 32. In particular, the catalyst monitoring system 44 may estimate the oxygen storage dynamics for the entire catalytic converter system 32, at various locations within the catalytic converter system 32, for subsets of cells within the catalytic converter system 32, and for each cell in the catalytic converter system 32. The catalyst monitoring system 44 determines the estimates 71 based on the selected catalytic converter model 64 and the pre- and post-cat oxygen measurements. The catalyst monitoring system 44 may also take into account the mid-cat oxygen measurement, if available, when determining the estimates 71 of oxygen storage dynamics. Additionally, the catalyst monitoring system 44 may determine the estimates 71 based on oxygen intake, which is the amount of oxygen present in the exhaust gases and the oxygen stored within the catalytic converter system 30 that is released and consumed when the amount of oxygen in the exhaust gases is insufficient.

The catalyst monitoring system 44 may also derive an overall (e.g., system-wide) oxygen storage estimate 73 at block 72. In one embodiment, the system oxygen storage estimate 73 may then be calculated based on one or more mathematical combinations (e.g., average, weighted average, etc.) of the oxygen storage estimates 71. For example, all of the estimates 71 may be added and then divided by the total number of cells. In another embodiment, one or more of the estimates 71 may be weighted differently (e.g., by adding or subtracting storage values) from other estimates 71, and then the weighted total may be divided by the total number of cells (e.g., number of estimates 71). In another example, a neural network may be trained to receive estimates 71 values as input, to combine the inputs, and to produce the system estimate 73 as output. The training may involve using historical data oxygen storage per cell data, simulation data, or a combination thereof Other techniques to combine the estimates 71 into the estimates 73 may include genetic algorithms, fuzzy logic, data mining techniques (e.g., clustering) and so on.

The catalyst monitoring system 44 also derives oxygen storage setpoints 76 for the catalytic converter system 32 based on the selected catalytic converter model 64 at block 74. Advantageously, the catalyst monitoring system 44 derives an oxygen storage setpoint 76 for each cell within the catalytic converter system 32. Indeed, the techniques described herein provide for the modeling of multiple or all cells the catalytic converter system 32 to derive individual setpoints 76 for each cell. In one embodiment, the individual setpoints 76 may be derived via a simulation (e.g., offline simulation), and then the derivations stored, for example, in one or more lookup tables for use during operations of the system 10. In another embodiment, the individual setpoints 76 may be derived during operations (e.g., real-time derivation) and used by the engine control unit 16 or catalyst monitoring system 44 in real-time.

The catalyst monitoring system 44 may then derive (block 77) an overall (e.g., system-wide) oxygen storage setpoint 78. The system oxygen storage setpoint 78 may be derived in a similar manner to the system oxygen storage estimate 73, for example by mathematical combinations, neural networks, data mining techniques, and so on. Further, the system oxygen storage setpoint 78 may be calculated as a combination of the oxygen storage setpoints 76 for the cells based on chemical kinetics or a particular reaction species conversion. For example, the system oxygen storage setpoint 78 may be calculated in such a way to maximize the efficiency of oxidizing carbon monoxide. In certain embodiments, the catalyst monitoring system 44 may also derive oxygen storage setpoints 76 for a subset of the cells within the catalytic converter system 30, as well as for various locations within the catalytic converter system 30.

At block 79, the catalyst monitoring system 44 compares the system oxygen storage setpoint 78 and/or the setpoints 76 to the oxygen storage estimates 72. The catalyst monitoring system 44 may compare the oxygen storage estimates 71 for each cell to the oxygen storage setpoints 76 for each cell, the system oxygen storage estimate 73 to the system oxygen storage setpoint 78, or both. The catalyst monitoring system 44 then provides the results of the comparison to the engine control unit 16, which uses the comparison to determine an AFR setpoint 81 at block 80. The engine control unit 16 then controls one or more actuators 28 (e.g., the throttle 14) to achieve the AFR setpoint at block 82.

In certain embodiments, the catalyst monitoring system 44 may store the received inputs, the selected catalytic converter model 64, and the oxygen storage estimates 71, 73 on the memory 48 at block 84. The catalyst monitoring system 44 then analyzes the saved data to determine improvements to the catalytic converter models 64 at block 86. This may be done using one or more machine learning algorithms, such as neural networks and data clustering. By using the analyzed data to improve the catalytic converter models 64, the catalyst monitoring system 44 may account for changes to the gas engine 12 and the catalytic converter system 32 over time, such as system aging and degradation. As will be appreciated, the catalyst monitoring system 44 may perform any analysis of the saved data while the gas engine system 10 is offline.

In addition to improving the catalytic converter models 64, the analyzed data may also be used to perform diagnostic tests on the catalytic converter system 32 at block 88. Based on the analyzed data, the catalyst monitoring system 44 may assign a health state 90 to the catalytic converter system 32 (e.g., in need of maintenance, excellent performance, etc.). In some embodiments, the health state 90 may include data relating to the catalytic converter system 32, such as the amount oxygen saturation, the amount of oxygen stored, or the percentage of a specific reaction species conversion out of all conversions. The catalyst monitoring system 44 may then communicate the health state 90 to the engine control unit 16, which can take action as necessary.

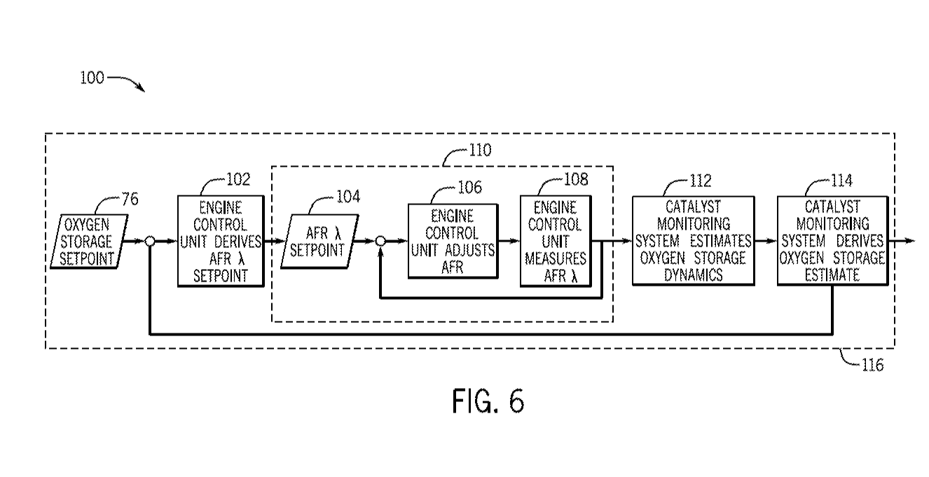

For example, FIG. 6 depicts an embodiment of a control process 100 that may be used to control the gas engine system 10. The control process 100 begins with deriving or retrieving the oxygen storage setpoints 76 and/or 78, as described above. Next, at block 102, the engine control unit 16 derives an AFR lambda setpoint 104. The AFR lambda setpoint 104 is a setpoint for the air-to-fuel equivalence ratio, which is often denoted using the Greek letter lambda. The air-to-fuel equivalence ratio measures the ratio of a value of an AFR to the stoichiometric AFR for that particular type of fuel. As such, deriving the AFR lambda setpoint 104 may depend, in part, on deriving the AFR setpoint 80 as described above. Accordingly, block 102 and the AFR lambda setpoint 104 may be considered as a specific example of block 80 (shown in FIG. 5) and the AFR setpoint 81 respectively.

At block 106, the engine control unit 106 may adjust the AFR of the engine 12 to achieve the AFR lambda setpoint 104. This action may include controlling the actuators 28 (e.g., the throttle 14) as described above with reference to block 82. After adjusting the AFR, the engine control unit 106 may then measure, based on data from the sensors 26, the actual air-to-fuel equivalence ratio of the engine 12 at block 108. The engine control unit 106 then compares the actual air-to-fuel equivalence ratio to the AFR lambda setpoint 104 and adjusts the AFR as necessary, thereby completing an AFR inner feedback loop 110.

At block 112, the catalyst monitoring system 44 may receive the measured air-to-fuel equivalence ratio and, based on the ratio and other inputs (e.g., the pre- and post-cat oxygen measurements), estimates the oxygen storage dynamics 71, 73 of the catalytic converter system 32 as described above with reference to blocks 62, 68, 70, and 72. After estimating the oxygen storage dynamics, the catalyst monitoring system 44 derives the oxygen storage setpoints 76 as described above at block 114. At least one of the newly derived oxygen storage setpoints 76 may then compared to the oxygen storage estimates, as described above with reference to block 79. The comparison is then used to derive a new AFR lambda setpoint 104, thereby completing an oxygen storage outer feedback loop 116.

Technical effects of the invention include controlling the AFR of a gas engine based in part on the actual and desired performance of a corresponding catalytic converter system. Certain embodiments may allow for more accurate determinations of the actual performance of a catalytic converter system. For example, the present catalyst monitoring system may estimate the oxygen storage dynamics of the catalytic converter systems based in part on models that account for varying operating states and conditions. The models may also be updated over time using previous estimates. Certain embodiments may also allow for determining the actual and desired performance for all or a portion of the catalytic converter system. For instance, the present catalyst monitoring system may determine oxygen storage estimates and oxygen storage setpoints for each cell in the catalytic converter system, for a subset of cells in the catalytic converter system, at different locations in the catalytic converter system, and for the catalytic converter system as a whole. Certain embodiments may also include analyzing the performance of the catalytic converter system and determining the health of the catalytic converter system based on the analysis. The technical effects and technical problems in the specification are exemplary and not limiting. It should be noted that the embodiments described in the specification may have other technical effects and can solve other technical problems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a controller comprising a processor configured to:
receive a first signal from a first oxygen sensor indicative of a first oxygen measurement, wherein the first oxygen sensor is disposed upstream of a catalytic converter system;
receive a second signal from a second oxygen sensor indicative of a second oxygen measurement, wherein the second oxygen sensor is disposed downstream of the catalytic converter system;
derive a plurality of oxygen storage estimates based on the first signal, the second signal, and a catalytic converter model, wherein each of the plurality of oxygen storage estimate comprises an oxygen storage estimate for a corresponding cell of a plurality of cells in the catalytic converter system;
derive a system oxygen storage estimate based on the plurality of oxygen storage estimates;
derive a system oxygen storage setpoint for the catalytic converter system based on the catalytic converter model; and
compare the system oxygen storage estimate with the system oxygen storage setpoint, wherein the processor is configured to apply the comparison during control of a gas engine.

2. The system of claim 1, wherein the processor is configured to:
derive an air-to-fuel ratio (AFR) setpoint based on the comparison; and
adjust a fuel actuator disposed in the gas engine based on the AFR setpoint.

3. The system of claim 1, wherein the processor is configured to receive data representative of an operating environment of the gas engine, and wherein the processor is configured to select the catalytic converter model from a plurality of offline catalytic converter models based on the data.

4. The system of claim 1, wherein the controller comprises a proportional-integral-derivative (PID) controller having an anti-windup mode.

5. The system of claim 1, wherein the processor is configured to:
derive a second system oxygen storage estimate for a subset of the plurality of cells in the catalytic converter system based on a combination of the plurality of the oxygen storage estimates; and
derive the system oxygen storage estimate based at least in part upon the second system oxygen storage estimate.

6. The system of claim 1, wherein the processor is configured to:
receive a third signal from a third oxygen sensor indicative of a third oxygen measurement, wherein the third oxygen sensor is disposed within the catalytic converter system; and
derive the plurality of oxygen storage estimates based on the first signal, the second signal, the third signal, and the catalytic converter model.

7. The system of claim 1, wherein the processor is configured to derive the system oxygen storage estimate based on a weighted average of the plurality of oxygen storage estimates.

8. The system of claim 1, wherein the processor is configured to derive the oxygen storage estimate for each of the plurality of cells based on chemical kinetics of the catalytic converter system.

9. The system of claim 8, wherein the processor is configured to derive the system oxygen storage setpoint at least to improve carbon monoxide oxidation efficiency of the catalytic converter system.

10. A system comprising:
a gas engine system comprising a gas engine fluidly coupled to a catalytic converter system;
a catalytic controller operatively coupled to the gas engine, and communicatively coupled to the catalytic converter, the catalytic controller comprising a processor configured to:
receive a first signal from a first oxygen sensor indicative of a first oxygen measurement, wherein the first oxygen sensor is disposed downstream of a gas engine exhaust outlet and upstream of the catalytic converter system;
receive a second signal from a second oxygen sensor indicative of a second oxygen measurement, wherein the second oxygen sensor is disposed downstream of the catalytic converter system;
select a first catalytic converter model from a plurality of offline catalytic converter models, wherein the selected catalytic converter model corresponds to an estimate of a behavior of the catalytic converter system;
derive a plurality of oxygen storage estimates based on the first signal, the second signal, and the first catalytic converter model, wherein each of the plurality of oxygen storage estimates comprises an oxygen storage estimate for a corresponding cell of a plurality of cells in the catalytic converter system;
derive a system oxygen storage estimate for the catalytic converter model based on a combination of the plurality of oxygen storage estimates;
derive a plurality of oxygen storage setpoints based on the first catalytic converter model, wherein each of the plurality of oxygen storage setpoints comprises an oxygen storage setpoint for the corresponding cell of the plurality of cells in the catalytic converter system;
derive a system oxygen storage setpoint for the catalytic converter system based on a combination of the plurality of oxygen storage setpoints;
compare the system oxygen storage estimate to the system oxygen storage setpoint; and
derive an air-to-fuel ratio (AFR) setpoint based on the comparison, wherein the AFR setpoint is applied to control the gas engine.

11. The system of claim 10, comprising a fuel controller operatively coupled to the gas engine, wherein the catalytic controller is configured to transmit the AFR setpoint to the fuel controller, and wherein the fuel controller adjusts one or more fuel actuators based on the AFR setpoint.

12. The system of claim 11, wherein the one or more fuel actuators comprise a valve providing fuel to the gas engine.

13. The system of claim 10, wherein the processor is configured to determine a health state of the catalytic converter system based on the plurality of oxygen storage estimates.

14. The system of claim 13, wherein the health state comprises at least one of an oxygen saturation amount, an amount of oxygen stored, a reaction species conversion percentage, or a combination thereof.

15. A tangible, non-transitory computer-readable medium comprising executable instructions configured to:
receive a first signal from a first oxygen sensor indicative of a first oxygen measurement, wherein the first oxygen sensor is disposed upstream of a catalytic converter system;
receive a second signal from a second oxygen sensor indicative of a second oxygen measurement, wherein the second oxygen sensor is disposed downstream of the catalytic converter system;
derive a plurality of oxygen storage estimates based on the first signal, the second signal, and a catalytic converter model, wherein each of the plurality of oxygen storage estimate comprises an oxygen storage estimate for each of a plurality of cells in the catalytic converter system;
derive a system oxygen storage estimate based on a combination of the plurality of oxygen storage estimates;
derive an oxygen storage setpoint for the catalytic converter system based on the catalytic converter model; and
compare the system oxygen storage estimate to the oxygen storage setpoint.

16. The tangible non-transitory computer-readable medium of claim 15, wherein the instructions are configured to receive a plurality of data describing an operating environment of the gas engine, and wherein the instructions are configured to select the catalytic converter model from a plurality of offline catalytic converter models based on the plurality of data.

17. The tangible non-transitory computer-readable medium of claim 15, wherein the instructions are configured to store the first signal and the second signal in a data repository as stored data and to adjust the catalytic converter model based on the first signal, the second signal, and the stored data.

18. The tangible non-transitory computer-readable medium of claim 17, wherein the plurality of data comprises at least one of a total air mass flow of the gas engine, a temperature of an exhaust gas of the gas engine, an oxygen storage capacity of an oxidation structure of the catalytic converter system, a Gibbs energy of the oxidation structure of the catalytic converter system, an inlet gas composition of the gas engine, or a combination thereof.

19. The tangible non-transitory computer-readable medium of claim 15, wherein the instructions are configured to derive a second system oxygen storage estimate for a location within the catalytic converter system based on the plurality of the oxygen storage estimates.

20. The tangible non-transitory computer-readable medium of claim 15, wherein the instructions are configured to determine a health state of the catalytic converter system based on the plurality of oxygen storage estimates and the system oxygen storage estimate.
